(19) United States
(12) Patent Application Publication
(10) Pub. No.: US 2023/0083825 A1
(43) Pub. Date: Mar. 16, 2023

(54) CIRCULAR SAW BLADE

(71) Applicant: C.M.T. UTENSILI S.P.A., Pesaro (PU) (IT)

(72) Inventor: Piergiorgio POZZO, Pesaro (PU) (IT)

(21) Appl. No.: 17/943,755

(22) Filed: Sep. 13, 2022

(30) Foreign Application Priority Data
Sep. 14, 2021 (IT) 102021000023654

(51) Int. Cl. B23D 61/04; B23D 61/02

(52) U.S. Cl. CPC B23D 61/04; B23D 61/021

(57) ABSTRACT

A circular saw blade comprising: a rigid central disk that is provided with a central pass-through hole adapted to be engaged by the machine-tool spindle; and a series of teeth that jut out from the periphery of the rigid central disk in a substantially radial direction, are suitably spaced along the periphery of the rigid central disk and have, on their front edge, a cutting insert; at least one of said teeth being provided with a plate-like protruding ridge or appendage that projects from the back of the tooth, towards the cutting insert of the following tooth, and is tapered towards its distal end; said protruding appendage and the front edge of the following tooth being shaped so as to form a substantially circular-shaped gullet in front of the following tooth.

### CROSS-REFERENCE TO RELATED APPLICATIONS

This patent application claims priority from Italian patent application no. 102021000023654 filed on Sep. 14, 2021, the entire disclosure of which is incorporated herein by reference.

### TECHNICAL FIELD

The invention relates to a circular saw blade.

More in detail, the invention relates to a demolition circular saw blade capable of quickly cutting building structures made of wood and/or plasterboard. Use to which the following description will make explicit reference without thereby losing in generality.

### BACKGROUND

As it is known, demolition circular saw blades are circular saw blades specifically structured to quickly cut walls, frames and other heterogeneous building structures mainly made of wood and/or plasterboard, so as to speed up demolition and/or renovation operations to be carried out in a building substantially lacking bearing structures made of bricks.

In other words, the demolition circular saw blades are specifically structured to cut/section, in a quick but rough manner, wood frames and/or wood and/or plasterboard panels, which can include, on the inside, needles and other small metal items, plastic pipes, electrical wires and/or small metal section bars.

In order to accomplish this particularly difficult task, the circular saw blade must have a rigid central disk with an increased thickness, whereas the cutting toothed crown is to be structured so as to quickly evacuate large quantities of shavings, ensuring anyway a good directing ability and a high capacity of incision in different types of material.

Unfortunately, since they have to simultaneously fulfil requirements requesting conflicting constructive solutions, demolition circular saw blades currently available in the market cannot offer performances that are comparable with the ones of circular saw blades for one single material.

### SUMMARY OF THE INVENTION

Aim of the present invention is to provide a demolition circular saw blade that has better performances than demolition circular saw blades currently on the market and, at the same time, is simple and economic to manufacture.

In accordance to these aims, according to the present invention there is provided a circular saw blade as defined in claim 1 and preferably, though not necessarily, in any one of the claims depending on it.

### BRIEF DESCRIPTION OF THE DRAWINGS

The invention will now be described with reference to the accompanying drawings showing a non-limiting embodiment thereof, wherein:

FIG. 1 is a perspective view of a circular saw blade realized according to the teachings of the present invention; whereas

FIG. 2 is a side view of part of the tool shown in FIG. 1.

### DESCRIPTION OF EMBODIMENTS

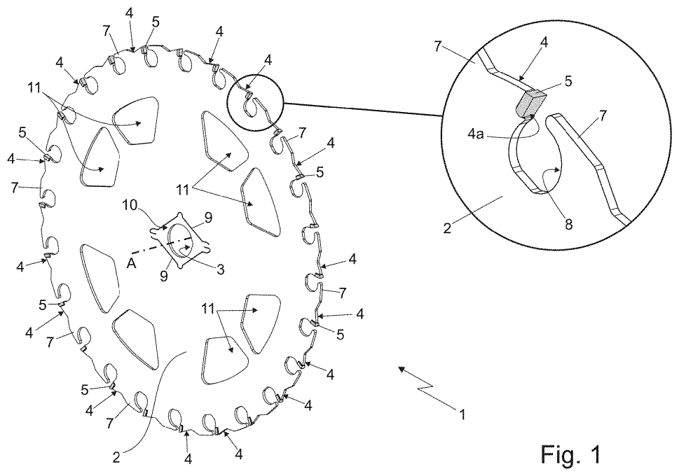

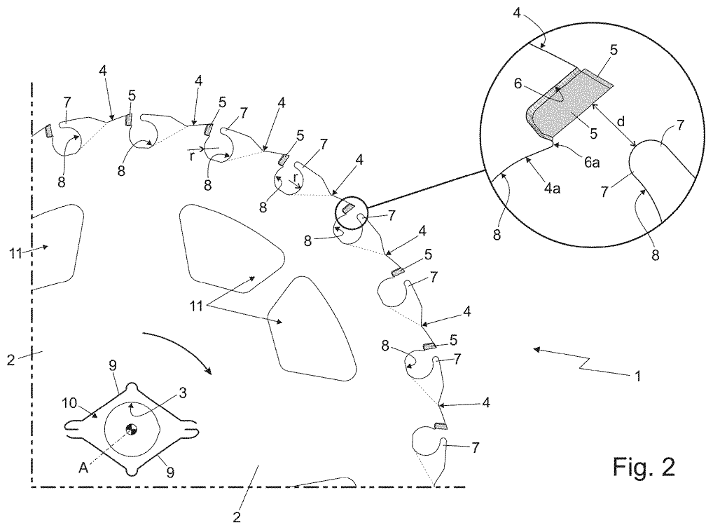

With reference to FIGS. 1 and 2, number 1 denotes as a whole a circular saw blade that finds particularly advantageous use in demolition and/or renovation operations to be carried out in buildings substantially lacking bearing structures made of bricks, i.e. with bearing structures and/or infill structures made of wood and/or plasterboard and/or the like.

In other words, the circular saw blade 1 is specifically structured to cut/section, in a quick and safe manner, walls, frameworks and other building structures made of wood and/or plasterboard, which can include, on the inside, needles and other small metal items, plastic pipes, electrical wires, small metal section bars, etcetera.

Hence, the circular saw blade 1 is adapted to be mounted on a traditional hand-held circular saw (not shown) or other similar machine tool so as to be driven into rotation about its central axis A, and comprises: a rigid central disk 2 preferably made of metal material, which has a nominal thickness preferably ranging between 0.8 and 3 mm (millimetres) and is provided with a preferably circular-shaped, central pass-through hole 3, which is arranged coaxial to axis A and is adapted to be engaged by the spindle of the hand-held circular saw or other similar machine tool; and a series of protruding teeth 4, that jut out from the periphery of the central disk 2 in a substantially radial direction and are suitably spaced along the periphery of the central disk 2.

More in detail, the teeth 4 are preferably made in a single piece with the rigid central disk 2 and are preferably spaced along the periphery of central disk 2 in a substantially even manner.

Moreover, each tooth 4 preferably juts out from the periphery of central disk 2 while remaining substantially coplanar to the rigid central disk 2.

In the example shown, in particular, the circular saw blade 1 has a nominal maximum diameter preferably equal to about 180 mm (millimetres) and is preferably provided with 24 protruding teeth. Furthermore, the rigid central disk 2 is preferably made of steel and has nominal thickness preferably equal to about 1.2 mm (millimetres).

With reference to FIGS. 1 and 2, the front edge 4a of at least one and, more conveniently, of each tooth 4 of the circular saw blade 1, in addition, is at least partially covered by an insert 5 made of metal or another hard material that forms the cutting part of the tooth 4.

More in detail, the cutting insert 5 is preferably accommodated/recessed inside a seat/notch 6 realized on the front edge 4a of the tooth, and is preferably firmly fixed to the body of tooth 4 via welding and/or brazing.

Clearly the circular saw blade 1 is driven into rotation about the central axis A so that each cutting insert 5 touches and penetrates the element to be cut before the corresponding tooth 4.

In the example shown, in particular, each cutting insert 5 of the circular saw blade 1 preferably consists of a small plate or block of Widia (tungsten carbide) or other hard metal or composite material, preferably substantially parallelepiped in shape, which is arranged astride the front edge 4a of the tooth 4. Preferably, the cutting insert 5, or rather the Widia block or the like, is furthermore dimensioned so as to jut out from both sides of the front edge 4a of protruding tooth 4, preferably in a substantially symmetrical manner relative to the midplane of central disk 2 and tooth 4.

In other words, the cutting insert 5, or rather the Widia block or the like, preferably has a maximum width exceeding the local thickness of tooth 4, and is fixed on the tooth 4 so that the two main and opposite side flanks of the cutting inert 5, or rather of the Widia block or the like, jut out from the sides of tooth 4.

With reference to FIG. 2, preferably the base of the seat/notch 6 accommodating the cutting insert 5, or rather the Widia block or the like, moreover is provided with a small protruding lip 6a, which extends beyond the front face of cutting insert 5, so as to oppose the tangential mechanical forces that tend to tilt the cutting insert 5 during cutting operations.

With reference to FIGS. 1 and 2, furthermore, one and, more conveniently, each tooth 4 of circular saw blade 1 is provided with a plate-like protruding ridge or appendage 7 which extend cantilevered from the back of tooth 4, towards the cutting insert 5 of the immediately following tooth 4, and is tapered towards its distal end. The rear protruding appendages 7 facilitate the expulsion of shavings during the cut.

More in detail, the rear protruding appendage 7 is preferably substantially hook-shaped and projects from the back of tooth 4 in a substantially tangential direction towards the cutting insert 5 of the immediately following tooth 4, up to arrive at a predetermined minimum distance d from said cutting insert 5 preferably smaller than 6 mm (millimetres) and, more conveniently, ranging between 2 and 5 mm (millimetres).

In addition, the protruding appendage 7 and the front edge 4a of the immediately following tooth 4 are shaped so as to form, in front of the immediately following tooth 4, a substantially circular gullet 8 that, for at least 60% of its perimeter, has a radius of curvature r preferably smaller than 6 mm (millimetres) and, more conveniently, ranging between 3 and 5 mm (millimetres).

In addition, the minimum distance d existing between the distal end of the rear protruding appendage 7 and the cutting insert 5 of the immediately following tooth 4 is preferably smaller than or equal to the radius of curvature r of the gullet 8 that the same protruding appendage 7 forms with the front edge 4a of the immediately following tooth 4.

In the example shown, in particular, the minimum distance d existing between the distal end of the rear protruding appendage 7 and the cutting insert 5 of the immediately following tooth 4 is preferably equal to about 3.8 mm (millimetres).

The radius of curvature r of the gullet 8 formed by the protruding appendage 7 and the front edge 4a of tooth 4, on the other hand, is preferably equal to about 4 mm (millimetres).

Preferably, the peripheral edge of gullet 8 moreover has, at the tangent point to the periphery of the rigid central disk 2, a substantially straight, small segment.

With reference to FIG. 2, preferably the small protruding lip 6a present at the base of the seat/notch 6 accommodating the cutting insert 5, or rather the Widia block or the like, moreover extends towards the distal end of the protruding appendage 7 of the immediately preceding tooth 4.

The teeth 4 with the corresponding cutting inserts 5 and rear protruding appendages 7 form the cutting toothed crown of the circular saw blade 1.

With reference to FIGS. 1 and 2, moreover the rigid central disk 2 is preferably provided with two or more oblong pass-through slots or slits 9, which are realized on the body of central disk 2, around the central pass-through hole 3, and are shaped so as to delimit a central flat sector 10, which is substantially coaxial to the tool rotation axis A and is selectively removable by the user. Furthermore, the central flat sector 10 is preferably shaped substantiality like a lozenge.

More in detail, in the example shown, the rigid central disk 2 is preferably provided with two substantially V-shaped pass-through slits 9, which are made on the body of central disk 2 on opposite sides of the central pass-through hole 3, in a substantially specular position relative to the tool rotation axis A, so as to form said substantially lozenge-shaped, central flat sector 10.

With reference to FIGS. 1 and 2, finally, the rigid central disk 2 is preferably provided with a series of cooling pass-through openings 11 that are made on the body of central disk 2, at a given distance from the central pass-through hole 3 and from central axis A, and are substantially evenly spaced around the central axis A.

More in detail, the pass-through openings 11 have an extension preferably greater than 1.5 cm² (square centi-metres). Furthermore, the pass-through openings 11 are arranged at a distance from the axis A preferably greater than 45% of the nominal value of the radius of central disk 2 and, more conveniently, ranging between 50% and 90% of the nominal value of the radius of the rigid central disk 2. In the example shown, in particular, the rigid central disk 2 is preferably provided with a plurality of pairs of cooling pass-through openings 11, which are angularly equally spaced around the central axis A.

Furthermore, each pair of pass-through openings 11 preferably consists of two pass-through openings 11 specular in shape.

More in detail, in the example shown herein, the rigid central disk 2 is preferably provided with four pairs of cooling pass-through openings 11, which are arranged around the tool central axis A at 90° from one another. Furthermore, each pair of pass-through openings 11 preferably consists of two pass-through openings 11 specular in shape, each having an extension preferably ranging between 2 and 2.5 cm² (square centimetres).

The operation of circular saw blade 1 is easily inferable from the description above and does not require further explanations.

The advantages connected to the particular structure of the toothed crown of circular saw blade 1 are remarkable.

Experimental tests have pointed out that the particular shape of the rear protruding ridges/appendages 7 and of the gullets 8 between the teeth 4 confers to the circular saw blade 1 remarkable directionality and a high capacity of incision in different types of material, ensuring anyway a very high ability of shaving evacuation.

In addition, the protruding lip 6a present at the base of the seat/notch 6 accommodating the cutting insert 5, or rather the Widia block or the like, prevents the detaching of the cutting insert 5 in case of impact against needles or small metal items during the cut.

It is finally clear that modifications and variants may be made to the circular saw blade 1 described above without however departing from the scope of protection of the present invention.

For example, the circular saw blade 1 may be provided with 40 protruding teeth.

1. A circular saw blade (1) comprising: a rigid central disk (2) which is provided with a central pass-through hole (3) adapted to be engaged by the machine-tool spindle; and
a series of teeth (4) that jut out from the periphery of the rigid central disk (2) in a substantially radial direction, are suitably spaced along the periphery of the rigid central disk (2), and have on their front edge (4a) a cutting insert (5);
said circular saw blade (1) being characterized in that at least one of said teeth (4) is provided with a plate-like protruding ridge or appendage (7) that extends cantilevered from the back of the tooth (4), towards the cutting insert (5) of the following tooth (4), and is tapered towards its distal end; said protruding appendage (7) and the front edge (4a) of the following tooth (4) being moreover shaped so as to form a substantially circular-shaped gullet (8) in front of the following tooth (4).

2. The circular saw blade according to claim 1, wherein said protruding appendage (7) extends cantilevered from the back of the tooth (4) in a substantially tangential direction.

3. The circular saw blade according to claim 1, wherein said protruding appendage (7) extends cantilevered from the back of the tooth (4) up to arrive at a minimum distance (d) from the cutting insert (5) of the following tooth (4) lower than 6 mm.

4. The circular saw blade according to claim 3, wherein said minimum distance (d) ranges between 2 and 5 mm.

5. The circular saw blade according to claim 1, wherein the rear protruding appendage (7) is substantially hook-shaped.

6. The circular saw blade according to claim 1, wherein said substantially circular-shaped gullet (8) has, for at least 60% of its perimeter, a radius of curvature (r) lower than 6 mm.

7. The circular saw blade according to claim 6, wherein said radius of curvature (r) has a value ranging between 3 and 5 mm (millimetres).

8. The circular saw blade according to claim 1, wherein the minimum distance (d) between the distal end of the protruding appendage (7) of the tooth (4) and the cutting insert (5) of the following tooth (4) is lower than or equal to the radius of curvature (r) of said substantially circular-shaped gullet (8).

9. The circular saw blade according to claim 1, wherein the rigid central disk (2) is provided with two or more oblong pass-through slots or slits (9), which are made on the body of the rigid central disk (2) around the central pass-through hole (3), and are shaped so as to delimit a flat sector (10) selectively removable by the user.

10. The circular saw blade according to claim 6, wherein said flat sector (10) is substantially lozenge-shaped.

11. The circular saw blade according to claim 1, wherein the rigid central disk (2) is provided with a series of cooling pass-through opening (11) which are made on the body of the central disk (2) at a given distance from the central pass-through hole (3), and are substantially evenly spaced around the tool central axis (A).

12. The circular saw blade according to claim 11, wherein said pass-through opening (11) have an extension greater than 1.5 cm².

13. The circular saw blade according to claim 11, wherein said pass-through opening (11) are located at a distance from the tool central axis (A) greater than 45% of the radius of the rigid central disk (2).
